(19) United States
(12) Patent Application Publication
(10) Pub. No.: US 2021/0012739 A1
(43) Pub. Date: Jan. 14, 2021

(54) DRIVING METHOD AND DRIVING DEVICE OF DISPLAY PANEL

(71) Applicant: HKC CORPORATION LIMITED, Shenzhen (CN)

(72) Inventor: Jianfeng SHAN, Shenzhen (CN)

(21) Appl. No.: 17/037,524

(22) Filed: Sep. 29, 2020

Related U.S. Application Data
(63) Continuation of application No. PCT/CN2019/076216, filed on Feb. 27, 2019.

(30) Foreign Application Priority Data
Jan. 30, 2019 (CN) 201910098294.9

(51) Int. Cl. G09G 3/36

(52) U.S. Cl. CPC G09G 3/3677; G09G 3/3688; G09G 2300/0452; G09G 3/3614; G09G 3/3607

(57) ABSTRACT

Disclosed are a driving method and a driving device of a display panel. The method includes: acquiring a first preset scanning driving signal, a second preset scanning driving signal, and a preset data driving signal, and shortening a driving time of the second preset scanning driving signal corresponding to the preset data driving signal; driving odd-numbered columns of sub-pixels in a first row and even-numbered columns of sub-pixels in a second row by the first preset scanning driving signal, and driving even-numbered columns of sub-pixels in the first row and odd-numbered columns of sub-pixels in the second row in the driving cycle by the second preset scanning driving signal.

### CROSS REFERENCE TO RELATED APPLICATIONS

This application is a continuation application of International application with No. PCT/CN2019/076216, filed on Feb. 27, 2019, which claims the benefit of Chinese Patent Application No. 201910098294.9, submitted to Patent Office of the People's Republic of China, filed on Jan. 30, 2019 and titled “DRIVING METHOD, DRIVING DEVICE AND DRIVING APPARATUS OF DISPLAY PANEL, AND STORAGE MEDIUM”, the entire contents of which are incorporated by reference in the present application.

### FIELD OF THE DISCLOSURE

The present disclosure relates to the field of liquid crystal display technologies, and in particular, to a driving method of display panel and a driving device of display panel.

### BACKGROUND

Most of the current large-size liquid crystal display panels are Vertical Alignment (VA) liquid crystal or In-Plane Switching (IPS) liquid crystal.

Comparing VA liquid crystal technology with IPS liquid crystal technology, it can be found that VA liquid crystal technology has higher production efficiency and a lower manufacturing cost, but it is worse than IPS liquid crystal technology in optical property performance, and there are obvious optical property defects.

Especially when it is suitable for a large-sized display panel, if the display panel is viewed with a small viewing angle during the driving process of the VA liquid crystal, for example, the lightness of the pixel will vary linearly with voltage if viewed from the front; the lightness of the pixel will quickly saturate with voltage if viewed with a larger viewing angle, resulting in serious deterioration of the image quality of the viewing angle. Obviously, there is a big difference between the ideal curve and the actual curve, which makes the gray scale which should be presented under a larger viewing angle seriously change due to deterioration, which leads to color cast.

In order to improve the color cast problem of the VA liquid crystal, a general solution is to further divide the sub-pixels into main pixels and secondary pixels, but after dividing the main pixels and the secondary pixels, if the display panel is viewed at a larger viewing angle, the tendency of the lightness of the pixel to change with voltage is close to the tendency of the voltage change when viewing the display panel with a small viewing angle.

However, the manner of dividing the main pixel and the secondary pixel will solve the color cast problem by spatially giving different driving voltages to the main and secondary pixels, thus causing the design of a metal routing or a Thin Film Transistor (TFT) element again to drive the secondary pixel, which will cause the transmissible open area to sacrifice, which in turn affects the panel transmittance.

Therefore, it can be considered that the current color cast solution will not affect the color cast phenomenon well because it will affect the panel transmittance.

### SUMMARY OF THE DISCLOSURE

The main object of the present application is to propose a driving method of a display panel and a device, which aims to effectively improve the color cast phenomenon without affecting the panel transmittance.

To achieve the above object, the present application provides a driving method of a display panel. The display panel includes a display array, the display array including pixel units arranged in an array; the driving method includes:

acquiring a first preset scanning driving signal, a second preset scanning driving signal, and a preset data driving signal, and shortening a driving time of the second preset scanning driving signal corresponding to the preset data driving signal;

taking a cycle in which two adjacent rows of sub-pixels are scanned as a driving cycle, and driving odd-numbered columns of sub-pixels in a first row and even-numbered columns of sub-pixels in a second row by the first preset scanning driving signal, and driving even-numbered columns of sub-pixels in the first row and odd-numbered columns of sub-pixels in the second row in the driving cycle by the second preset scanning driving signal.

Further, to achieve the above object, the present application further proposes a driving method of a display panel. The display panel includes a display array, the display array includes pixel units arranged in an array, and the pixel units include a first pixel unit and a second pixel unit. The first pixel unit and the second pixel unit are alternately disposed, and polarities of two adjacent sub-pixels are opposite; the driving method includes:

acquiring a first preset scanning driving signal, a second preset scanning driving signal, and a preset data driving signal, and shortening a driving time of the second preset scanning driving signal corresponding to the preset data driving signal;

taking a cycle in which two adjacent rows of sub-pixels are scanned as a driving cycle, and driving odd-numbered columns of sub-pixels in a first row and even-numbered columns of sub-pixels in a second row by the first preset scanning driving signal, and driving even-numbered columns of sub-pixels in the first row and odd-numbered columns of sub-pixels in the second row in the driving cycle by the second preset scanning driving signal and driving sub-pixels in a dot-inversion manner.

Further, to achieve the above object, the present application further proposes a driving device of a display panel. The display panel includes a display array which includes pixel units arranged in an array; the driving device includes a processor and a nonvolatile memory, the non-volatile memory storing executable instructions, and the processor executing the executable instructions including:

acquiring a first preset scanning driving signal, a second preset scanning driving signal, and a preset data driving signal, and shortening a driving time of the second preset scanning driving signal corresponding to the preset data driving signal; and

taking a cycle in which two adjacent rows of sub-pixels are scanned as a driving cycle, and driving odd-numbered columns of sub-pixels in a first row and even-numbered columns of sub-pixels in a second row by the first preset scanning driving signal, and driving even-numbered columns of sub-pixels in the first row and odd-numbered columns of sub-pixels in the second row in the driving cycle by the second preset scanning driving signal.

Further, to achieve the above object, the present application further provides a display device including: a display panel, a memory, a processor, and a driver of the display panel stored in the memory and capable of running on the processor. The display panel includes a display array including pixel units arranged in an array. The driver of the display panel is configured to be implemented by the processor to realize steps of the driving method as described above.

Further, to achieve the above object, the present application further provides a storage medium on which a driver for a display panel is stored. When the driver of the display panel is implemented by a processor, the steps of the above described driving method are realized.

The present disclosure uses two scanning driving signals to drive sub-pixels of two adjacent rows in an interspersed manner, and shortens the driving time of the preset scanning driving signal in the scanning driving signal with respect to the preset data driving signal, thereby there are differences in the driving time of the two scanning driving signals, so that the charging ability of the sub-pixels on the two rows of scanning driving signals is different, and the adjacent sub-pixels of the same column are driven by the driving method of high/low voltage interleaving arrangement, thereby achieving the purpose of reducing the color cast.

### BRIEF DESCRIPTION OF THE DRAWINGS

FIG. 1 is a structural schematic diagram of a display device of a hardware operating environment involved in an embodiment of the present application;

FIG. 2a is a structural schematic view of an embodiment of an exemplary display array;

FIG. 2b is a schematic diagram of driving timing of an exemplary display array;

FIG. 3a is a structural schematic view of an embodiment of a display array of the present disclosure;

FIG. 3b is a schematic diagram of the driving timing of an embodiment of a display array of the present disclosure;

FIG. 4 is a flow chart of a first embodiment of a driving method of a display panel of the present application;

FIG. 5 is a schematic diagram of the driving timing after inversion according to an embodiment of the present disclosure;

FIG. 6 is a structural schematic view of another embodiment of a display array of the present disclosure;

FIG. 7 is a structural schematic view of an embodiment of a display device of the present disclosure; and

FIG. 8 is a structural schematic view of another embodiment of a driving device of a display panel of the present application.

The object realization, function characteristics and advantages of this application will be further described in reference to embodiments and accompanying drawings.

### DETAILED DESCRIPTION OF THE EMBODIMENTS

It should be understood that the specific embodiments described herein are only for illustrating but not for limiting the present application.

Referring to FIG. 1, which is a structural schematic diagram of a display panel of a hardware operating environment involved in an implementation of the present application;

As shown in FIG. 1, the display panel may include a processor 1001, such as a CPU, a communication bus 1002, a user interface 1003, a network interface 1004, and a memory 1005. Wherein the communication bus 1002 is configured to realize connection and communication between the assemblies. The user interface 1003 may include a display, and an input unit such as a keyboard. Alternatively, the user interface 1003 may further include a standard wired interface and a standard wireless interface. The network interface 1004, alternatively, may include a standard wired interface and a standard wireless interface (such as a WiFi interface). The memory 1005 can be a high-speed RAM memory, and can also be a non-volatile memory, such as a magnetic disk memory. The memory 1005, alternatively, can also be a storage device independent from the aforementioned processor 1001. The display panel 1006 can be a liquid crystal display panel, and can also be other display panels that can achieve the same or similar functions.

A person skilled in the art may understand that the display panel structure shown in FIG. 1 does not limit the terminal, and the terminal may comprise more or less components as shown in the figure, or have combinations of certain components or different arrangement of components.

As shown in FIG. 1, the memory 1005, as a storage medium, may include an operating system, a network communication module, a user interface module and a driver of a display panel.

In the display panel shown in FIG. 1, the network interface 1004 is mainly used to connect the network and perform data communication with the internet; the user interface 1003 is mainly used to connect the user terminal and perform data communication with the terminal; the display panel of the present disclosure calls the driver of the display panel stored in the memory 1005 by the processor 1001 and executes the driving method of the display panel.

Based on the above hardware structure, an embodiment of a driving method of the display panel of the present disclosure is proposed.

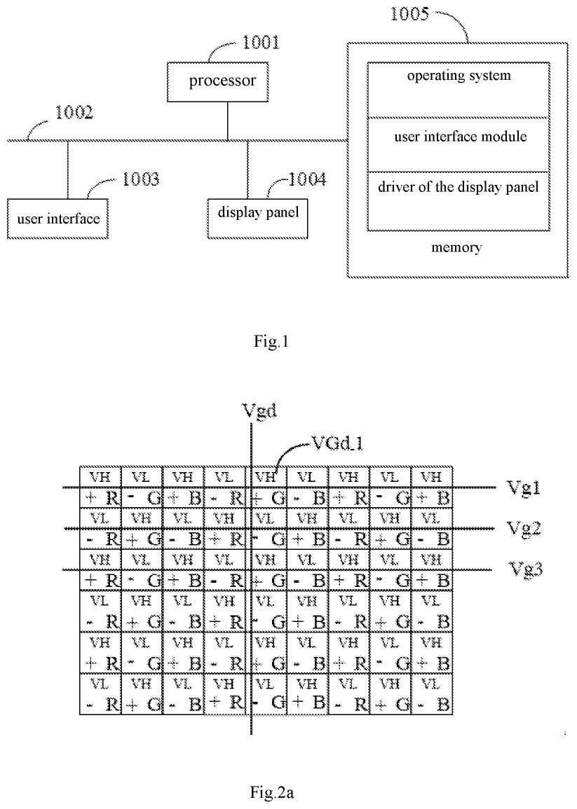

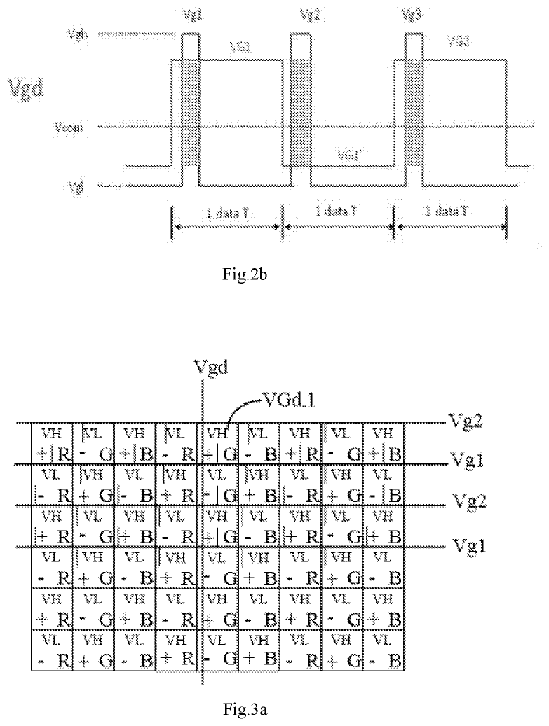

Referring to FIG. 2a as a structural schematic diagram of an exemplary display array. The original liquid crystal display panel is designed for the scanning driving signals to pass through the same row of sub-pixels, and each row of scanning driving is as shown in the schematic diagram of the driving timing of the display array as illustrated in FIG. 2b, where Vg1, Vg2, Vg3, etc. indicate that the driving voltages of the scanning driving signals of the respective rows are the same, and the relative timing and the overlapping time of the scanning driving signals with respect to the timing of the data driving signals are the same, and therefore each sub-pixel has the same charging capability. In order to solve the color cast problem, the high voltage sub-pixel and the low voltage sub-pixel are required to be interspersed in terms of driving to achieve the effect of improving the color cast. Therefore, the data driving voltage Vgd needs to be sequentially driven according to the high and low voltages of each sub-pixel, as shown in FIG. 2a, the high-voltage sub-pixel driving voltage VGd_1, the next adjacent low-voltage sub-pixel VGd_2, and high voltage and low voltage sub-pixel signal driving on the same column of sub-pixels sequentially. In addition to the difference in the driving signal, if the driving polarity of the two adjacent sub-pixels is different, as the resolution of the panel increases, the number of sub-pixels in the same row increases, which increases the driving frequency to increase the load of the driver IC, increasing the risk of driver IC power consumption and driver IC temperature increase.

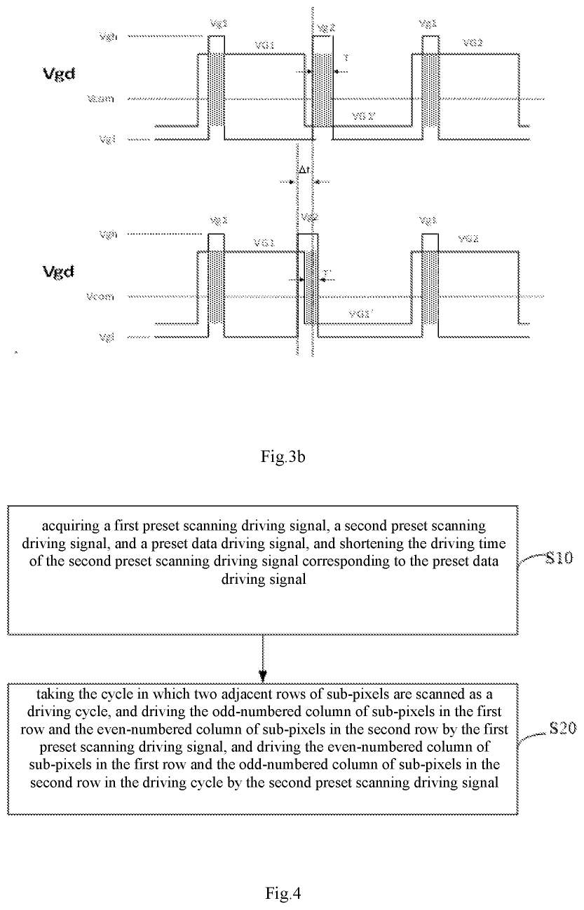

Referring to FIG. 3a as a structural schematic diagram of an embodiment of a display array according to an embodiment of the present disclosure, and FIG. 3b is a schematic diagram of driving timing corresponding to the display array of the embodiment. The display panel of the display array may be a liquid crystal display panel, and may also be other display panels that can achieve the same or similar functions, which is not limited in the present embodiment. In the present embodiment, a liquid crystal display panel is taken as an example for description. The display panel includes a display array, including pixel units arranged in an array. The pixel unit includes a first pixel unit and a second pixel unit which are alternately disposed in a first direction and in a second direction. The pixel unit includes a first sub-pixel, a second sub-pixel, and a third sub-pixel, and the first sub-pixel, the second sub-pixel, and the third sub-pixel correspond to a red sub-pixel (R) and a green sub-pixel (G) and a blue sub-pixel (B) respectively, wherein the first direction is a row direction and the second direction is a column direction.

Referring to FIG. 4, which is a flow chart of a first embodiment of a driving method of a display panel of the present application.

In the first embodiment, the driving method of the display panel includes the following steps:

step S10 of acquiring a first preset scanning driving signal, a second preset scanning driving signal, and a preset data driving signal, and shortening the driving time of the second preset scanning driving signal corresponding to the preset data driving signal.

It should be noted that, as shown in FIG. 3a, the first preset scanning driving signal is Vg1, the second preset scanning driving signal is Vg2, and the preset data driving signal is Vgd, which shortens the driving time of the second preset scanning driving signal corresponding to the preset data driving signal. As shown in FIG. 3b, the second preset scanning driving signal corresponds to the driving time T′ before the improvement of the preset data driving signal. As can be seen from the figure, the relative driving time of Vg2 with respect to the preset data driving signal is adjusted ahead by Δt, so that the charging ability of the two sub-pixels adjacent to the same column is different, so that the charging capacity of the sub-pixels connected by Vg2 is smaller than that of the sub-pixels connected by Vg1, causing the two adjacent sub-pixels in the same column to be alternately disposed by high voltage and low voltage.

Step S20 of taking the cycle in which two adjacent rows of sub-pixels are scanned as a driving cycle, and driving the odd-numbered column of sub-pixels in the first row and the even-numbered column of sub-pixels in the second row by the first preset scanning driving signal, and driving the even-numbered column of sub-pixels in the first row and the odd-numbered column of sub-pixels in the second row in the driving cycle by the second preset scanning driving signal.

It should be noted that, as shown in FIG. 3a and the corresponding 4b driving timing, in order to realize the high and low voltage interleaving driving arrangement manner of adjacent R, and B sub-pixels, Vg1 is a row of one odd-numbered column of sub-pixels and an adjacent row of one even-numbered column of co-scanning drive circuit and scanning driving signal. The pixel scans the driving line and the scan driving signal, and Vg2 is the same as Vg1 for a row of one odd-numbered column of sub-pixels and an adjacent row of one even-numbered column of sub-pixels of co-scanning drive circuit and scanning driving signal. As shown in FIG. 3b, the present embodiment uses a dot inversion data driving method to control the scanning driving signal with respect to the data driving signal time. The driving time of Vg2 with respect to the data driving signal Vgd is advanced by Δt compared with that of Vg1 with respect to the data driving signal Vgd, such that the charging time T′ of the Vg2 scanning driving signal with respect to the data driving signal Vgd is less than the charging time T of the Vg1 scanning driving signal with respect to the data driving signal Vgd, so that the equivalent charging voltage of the corresponding sub-pixel is lowered to form a so-called low voltage sub-pixel.

It can be understood that the scanning switching sequence that controls Vg2 is shorter than the charging signal time of the data driving signal, which is relatively long compared with the charging signal time corresponding to the Vg1 scanning switching sequence, so that the sub-pixel charging capability corresponding to the scanning drive circuit Vg2 is deteriorated, and the sub-pixel charging capability corresponding to the Vg1 scanning circuit becomes strong, thereby achieving the difference between the high-voltage sub-pixel charging and the low-voltage sub-pixel charging, thereby achieving the effect of improving the color cast.

The present application uses two scanning driving signals to drive sub-pixels of two adjacent rows in an interspersed manner, and drives the driving time of the preset scanning driving signal in the scanning driving signal with respect to the preset data driving signal, thereby there are differences in the driving time of the two scanning driving signals, so that the charging ability of the sub-pixels on the two rows of scanning driving signals is different, and the adjacent sub-pixels of the same column are driven by the driving method of high/low voltage interleaving arrangement, thereby achieving the purpose of reducing the color cast.

Optionally, before step S10, the method further includes:

setting the polarities of two adjacent sub-pixels to be opposite. And after step S20, the method further includes:

driving the same column of sub-pixels with the same data driving signal.

It can be understood that, as shown in FIG. 3b, the sub-pixel positive polarity driving signals of the G row are VG1, VG2, VG3, and the negative polarity driving dynamic signals are VG1′, VG2′, VG3′ . . . . When the frame of Frame1 is timed, the equivalent driving voltage VGd_1 of the high voltage sub-pixel, that is, the switching sequence of the positive polarity driving signal Vgd=VG1 and the Vg1 scanning driving signal is longer with respect to the charging signal of the data driving signal, the next adjacent low voltage sub-pixel VGd_2 is the negative polarity driving voltage Vgd=VG1′, and the switching sequence of the scanning driving signal of Vg2 is shorter with respect to the charging signal of the data driving signal, that is, the equivalent driving voltage VGd_1>VGd_2. In a similar way, the equivalent driving voltage VGd_3 of the high voltage sub-pixel, that is, the switching sequence of the positive polarity driving signal Vgd=VG2 and the Vg1 scanning driving signal is longer with respect to the charging signal of the data driving signal, the next adjacent low voltage sub-pixel VGd_4 is the negative polarity driving voltage Vgd=VG2′, and the switching sequence of the scanning driving signal of Vg2 is shorter with respect to the charging signal of the data driving signal, that is, the equivalent driving voltage VGd_3>VGd_4. Therefore, the adjacent sub-pixels in the same column are driven by the driving method of high and low voltage interleaving, thereby achieving the purpose of reducing color cast.

Optionally, after driving the same column of sub-pixels with the same data driving signal, the method further includes:

driving the two adjacent sub-pixels in the same column by the preset data driving signal, and the preset data driving signal is an average value of historical driving signals of two adjacent sub-pixels.

It should be noted that the driving signals of the two sub-pixels adjacent to each other in the same history are the driving signals of the two sub-pixels adjacent to each other in the same row before the improvement. The equivalent voltages of the equivalent driving voltages VGd_1 and VGd_2 of the adjacent two sub-pixels in the same column are respectively driven by the positive polarity driving voltage Vgd=VG1 and the negative polarity driving voltage Vgd=VG1′. The positive polarity driving voltage VG1 and the negative polarity driving voltage VG1′ may preferably be average signals of the original pixel signals Gd1 and Gd2 signals, and are 0 to 255 signals for the 8-bit driving signal, that is, G1=(Gd1+Gd2)/2, the positive polarity driving voltage VG1 and the negative polarity driving voltage VG1′ corresponding to the G1 signal. The equivalent voltages of VGd_3 and VGd_4 are driven by the positive polarity driving voltage Vgd=VG2 and the negative polarity driving voltage Vgd=VG2′ respectively, then the average signal of the original frame pixel signals Gd3 and Gd4 signal may be preferably 0 to 255 signals for the 8-bit driving signal, that is, G2=(Gd3+Gd4)/2, the positive polarity driving voltage VG2 and the negative polarity driving voltage VG2′ corresponding to G2 signal.

Optionally, after step S10, the method further includes:

receiving an inversion signal, inverting the first preset scanning driving signal and the preset data driving signal according to the inversion signal, obtaining an inverted first preset scanning driving signal and an inverted preset data driving signal and shortening the driving time of the inverted first preset scanning driving signal, so that the driving time of the first preset scanning driving signal corresponding to the inverted preset data driving signal is shortened.

Continuing with the timing of 4b, the sub-pixels of the G column in the figure, wherein sub-pixels of R and B column are the same, Vg1 is the scanning driving voltage corresponding to the high-voltage sub-pixels VGd_1, VGd_3, and VGd_5 and Vg2 is the scanning driving voltage corresponding to the low-voltage sub-pixels VGd_2, VGd_4, and VGd_6, wherein the switching sequence of the Vg1 scanning driving signal is longer than the charging signal VG1 of the data driving signal, and the switching sequence is shorter than the charging signal VG1′ of the data driving signal with respect to the switching sequence of Vg2 scanning driving signal.

In the present embodiment, as the driving signals of the adjacent two frames are inversed, as shown in FIG. 5, the switch of the scanning driving signal switches the control of the charging time of the data driving signal, that is, the switching sequence of the Vg1 scanning driving signal is shorter than the correct charging signal VG1′ of the data driving signal, and the switching sequence is longer than the charging signal VG1 of the data driving signal with respect to the switching sequence of Vg2 scanning driving signal. In this way, sub-pixels with different timings of high and low voltage signals can be realized, and the difference between the high-voltage sub-pixel and the low-voltage sub-pixel cannot be clearly seen by naked eyes, and there is no defect that the resolution is lowered.

Optionally, the pixel unit includes a first pixel unit and a second pixel unit, which are alternately disposed in a column direction, wherein the first pixel unit includes red sub-pixels and green sub-pixels, blue sub-pixels and the second pixel unit includes blue sub-pixels, white sub-pixels, red sub-pixels, and green sub-pixels fell into place.

Optionally, the step S20 includes:

taking the cycle in which two adjacent rows of sub-pixels are scanned as a driving cycle, the red sub-pixels and the blue sub-pixels in the first row and the white sub-pixels and the green sub-pixels in the second row are driven by the first preset scanning driving signal, and the green sub-pixels and the white sub-pixels in the first row and the blue sub-pixels and the red sub-pixels in the second row in the driving cycle are driven by the second preset scanning driving signal.

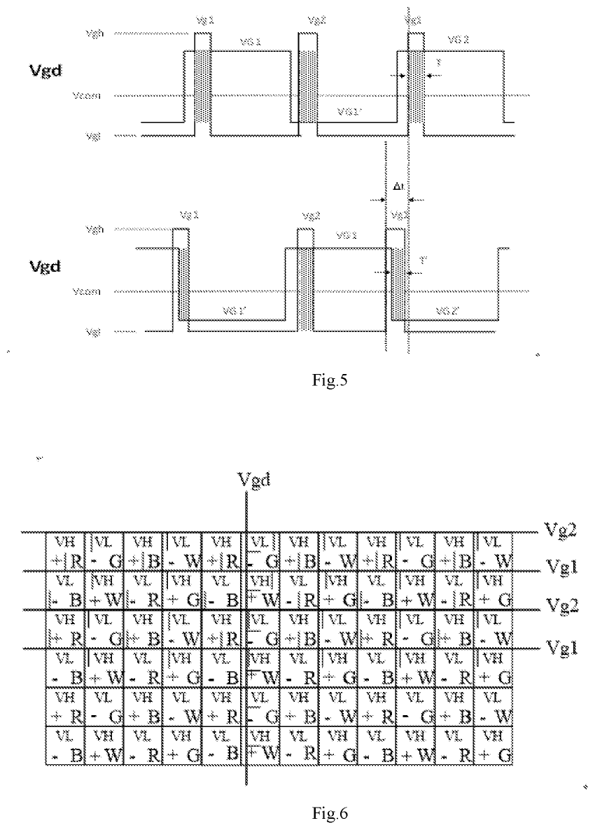

As shown in FIG. 6, it is proposed to use WRGB sub-pixels as a method of the high/low voltage driving for improving the color cast and to drive sub-pixels of the same row by Vg1 and Vg2 voltage interleaving arrangement. And the sub-pixel of the same column is driven by the preset data driving signal Vgd, and is arranged with high and low voltages of each sub-pixel of WRGB, and is inverted by a dot inversion driving method, thereby realizing the interleaving arrangement of high voltage sub-pixels and low voltage sub-pixels of four sub-pixels. Therefore, the adjacent sub-pixels of the same column are driven by the driving method of high and low voltage interleaving arrangement, thereby achieving the purpose of reducing color cast.

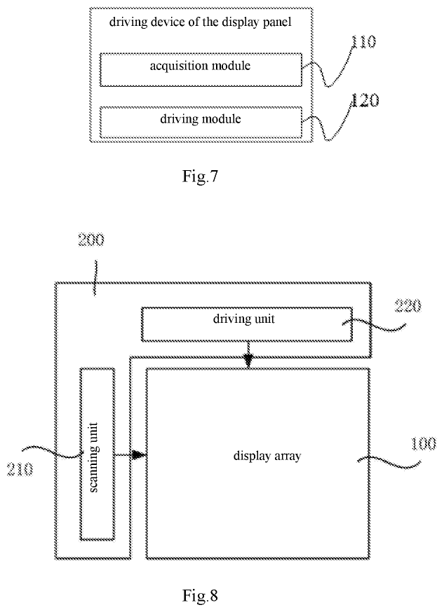

Further, the embodiment of the present application also proposes a driving device of a display panel. As shown in FIG. 7, the display panel includes a display array, including a sub-pixel unit that is arranged in an array; the driving device of the display panel includes:

an acquisition module 110 configured to acquire a first preset scanning driving signal, a second preset scanning driving signal, and a preset data driving signal, and shorten the driving time of the second preset scanning driving signal corresponding to the preset data driving signal;

a driving module 120 configured to take the cycle in which two adjacent rows of sub-pixels are scanned as a driving cycle, and drive the odd-numbered column of sub-pixels in the first row and the even-numbered column of sub-pixels in the second row by the first preset scanning driving signal, and drive the even-numbered column of sub-pixels in the first row and the odd-numbered column of sub-pixels in the second row in the driving cycle by the second preset scanning driving signal.

As shown in FIG. 8, the driving device of the display panel further includes a display array 100 and a driving module 200. The driving module 200 may include a scanning unit 210 and a driving unit 220. The scanning unit 210 is configured to output a scanning driving signal and generally scans the pixel unit row by row, and the driving unit 220 outputs a data driving signal, so that the pixel unit receives the driving data for display when it is scanned.

The driving module 200 can be understood with reference to the foregoing embodiment. After the processing, the sub-pixels of two adjacent two rows are driven in an interspersed manner by using two scanning driving signals, and the driving time of the preset scanning driving signal in the scanning driving signal is driven with respect to the preset data driving signal, thereby there are differences in the driving time of the two scanning driving signals, so that the charging ability of the sub-pixels on the two rows of scanning driving signals is different, and the adjacent sub-pixels of the same column are driven by the driving method of high/low voltage interleaving arrangement, thereby achieving the purpose of reducing the color cast.

Further, the present application further provides a storage medium on which a driver for a display panel is stored. When the driver of the display panel is implemented by the processor, the following steps of the driving method of the display panel are realized:

acquiring a first preset scanning driving signal, a second preset scanning driving signal, and a preset data driving signal, and shortening the driving time of the second preset scanning driving signal corresponding to the preset data driving signal;

taking a cycle in which two adjacent rows of sub-pixels are scanned as a driving cycle, and driving the odd-numbered column of sub-pixels in the first row and the even-numbered column of sub-pixels in the second row by the first preset scanning driving signal, and driving the even-numbered column of sub-pixels in the first row and the odd-numbered column of sub-pixels in the second row in the driving cycle by the second preset scanning driving signal.

The present application uses two scanning driving signals to drive sub-pixels of two adjacent rows in an interspersed manner, and drives the driving time of the preset scanning driving signal in the scanning driving signal with respect to the preset data driving signal, thereby there are differences in the driving time of the two scanning driving signals, so that the charging ability of the sub-pixels on the two rows of scanning driving signals is different, and the adjacent sub-pixels of the same column are driven by the driving method of high/low voltage interleaving arrangement, thereby achieving the purpose of reducing the color cast.

It should be noted that terms “comprising”, “including” or any other variants herein are intended to cover the non-exclusive including, thereby making that the process, method, merchandise or system comprising a series of elements comprise not only those elements but also other elements that are not listed explicitly or the inherent elements to the process, method, merchandise or system. In the case of no more limitations, the element limited by the sentence “comprising a . . . ” does not exclude that there exists another same element in the process, method, merchandise or system comprising the element.

The serial numbers of the embodiments of the present application are merely for the description, and do not represent the advantages and disadvantages of the embodiments.

Through the description of the above implementations, those skilled in the art can clearly understand that the foregoing embodiment method can be implemented by means of software plus a necessary general hardware platform, and of course, can also be implemented through hardware, but in many cases, the former is better. Based on the understanding, the technical schemes of the present application in essence illustrate the part contributing to the prior art or the part of the technical schemes in the form of a software product, the computer software product is stored in a storage medium (such as ROM/RAM, disk, CD), including some instructions for making a terminal device (mobile phone, computer, server, air-conditioner or network device and the like) implement the methods in the embodiments of the present application.

The above is only the alternative embodiment of the present application, which does not limit the patent scope of the present disclosure, and any equivalent structure or process made by using the specification and the drawings of the present application or direct or indirect applications in other related technical fields should be contained in the scope of patent protection in a similar way.

What is claimed is:

1. A driving method of a display panel, wherein the display panel comprises a display array, display array comprising pixel units that are arranged in an array; the driving method of the display panel comprises:
acquiring a first preset scanning driving signal, a second preset scanning driving signal, and a preset data driving signal, and shortening a driving time of the second preset scanning driving signal corresponding to the preset data driving signal; and
taking a cycle in which two adjacent rows of sub-pixels are scanned as a driving cycle, and driving odd-numbered columns of sub-pixels in a first row and even-numbered column of sub-pixels in a second row by the first preset scanning driving signal, and driving even-numbered columns of sub-pixels in the first row and odd-numbered columns of sub-pixels in the second row in the driving cycle by the second preset scanning driving signal.

2. The driving method according to claim 1, wherein before acquiring a first preset scanning driving signal, a second preset scanning driving signal, and a preset data driving signal, and shortening a driving time of the second preset scanning driving signal corresponding to the preset data driving signal, the method further comprises:
setting polarities of two adjacent sub-pixels to be opposite.

3. The driving method according to claim 2, wherein after taking a cycle in which two adjacent rows of sub-pixels are scanned as a driving cycle, and driving odd-numbered columns of sub-pixels in a first row and even-numbered column of sub-pixels in a second row by the first preset scanning driving signal, and driving even-numbered column of sub-pixels in the first row and odd-numbered column of sub-pixels in the second row in the driving cycle by the second preset scanning driving signal, the method further comprises:
driving a same column of sub-pixels with a same data driving signal.

4. The driving method according to claim 3, wherein after driving a same column of sub-pixels with a same data driving signal, the method further comprises:
driving two adjacent sub-pixels in the same column by the preset data driving signal, and the preset data driving signal is an average value of historical driving signals of the two adjacent sub-pixels.

5. The driving method according to claim 1, wherein after acquiring a first preset scanning driving signal, a second preset scanning driving signal, and a preset data driving signal, and shortening a driving time of the second preset scanning driving signal corresponding to the preset data driving signal, the method further comprises:
receiving an inversion signal, inverting the first preset scanning driving signal and the preset data driving signal according to the inversion signal, obtaining an inverted first preset scanning driving signal and an inverted preset data driving signal and shortening a driving time of the inverted first preset scanning driving signal, so that a driving time of the first preset scanning driving signal corresponding to the inverted preset data driving signal is shortened.

6. The driving method according to claim 5, wherein after acquiring a first preset scanning driving signal, a second preset scanning driving signal, and a preset data driving signal, and shortening a driving time of the second preset scanning driving signal corresponding to the preset data driving signal, the method further comprises:
a switching sequence of the inverted first preset scanning driving signal is longer than a charging time of the preset data driving signal, and a switching sequence of the inverted second preset scanning driving signal is shorter than a charging time of a charging signal of the preset data driving signal.

7. The driving method according to claim 1, wherein the pixel units comprise a first pixel unit and a second pixel unit, the first pixel unit comprise red sub-pixels and green sub-pixels, blue sub-pixels and white sub-pixels sequentially arranged, and the second pixel units comprise blue sub-pixels, white sub-pixels, red sub-pixels, and green sub-pixels sequentially arranged;
taking a cycle in which two adjacent rows of sub-pixels are scanned as a driving cycle, and driving odd-numbered columns of sub-pixels in a first row and even-numbered columns of sub-pixels in a second row by the first preset scanning driving signal, and driving even-numbered columns of sub-pixels in the first row and odd-numbered columns of sub-pixels in the second row in the driving cycle by the second preset scanning driving signal, comprises:
taking the cycle in which two adjacent rows of sub-pixels are scanned as the driving cycle, and driving the red sub-pixels and the blue sub-pixels in the first row and the white sub-pixels and the green sub-pixels in the second row by the first preset scanning driving signal, and driving the green sub-pixels and the white sub-pixels in the first row and the blue sub-pixels and the red sub-pixels in the second row in the driving cycle by the second preset scanning driving signal.

8. The driving method according to claim 1, wherein before acquiring a first preset scanning driving signal, a second preset scanning driving signal, and a preset data driving signal, the method further comprises:
disposing alternately the first pixel unit and the second pixel unit in a first direction and a second direction, wherein the first direction is a row direction and the second direction is a column direction.

9. The driving method according to claim 1, wherein before acquiring a first preset scanning driving signal, a second preset scanning driving signal, and a preset data driving signal, the method further comprises:
scanning the odd-numbered columns of sub-pixels in the first row and the even-numbered columns of sub-pixels in the second row by a same scanning driving line and a same scanning driving signal, and scanning the even-numbered column of sub-pixels in the first row and the odd-numbered column of sub-pixels in the second row in the driving cycle by a same scanning driving line and a same scanning driving signal.

10. The driving method according to claim 1, wherein before acquiring a first preset scanning driving signal, a second preset scanning driving signal, and a preset data driving signal, the method further comprises:
the first preset scanning driving signal and the second preset scanning driving signal driving sub-pixels of two adjacent rows in an interspersed manner.

11. A driving method of a display panel, wherein the display panel comprises a display array, the display array comprises pixel units arranged in an array, and the pixel units comprises a first pixel unit and a second pixel unit, the first pixel units and the second pixel units are alternately disposed, and polarities of two adjacent sub-pixels are opposite; the driving method comprises:
acquiring a first preset scanning driving signal, a second preset scanning driving signal, and a preset data driving signal, and shortening a driving time of the second preset scanning driving signal corresponding to the preset data driving signal; and
taking a cycle in which two adjacent rows of sub-pixels are scanned as a driving cycle, and driving odd-numbered columns of sub-pixels in the first row and even-numbered columns of sub-pixels in the second row by the first preset scanning driving signal, and driving even-numbered column of sub-pixels in the first row and odd-numbered column of sub-pixels in the second row in the driving cycle by the second preset scanning driving signal and driving sub-pixels in a dot-inversion manner.

12. A driving device of a display panel, wherein the display panel comprises a display array, the display array comprises pixel units arranged in an array; the driving device comprises a processor and a nonvolatile memory, the non-volatile memory storing executable instructions, and the processor executing the executable instructions comprising:
acquiring a first preset scanning driving signal, a second preset scanning driving signal, and a preset data driving signal, and shortening a driving time of the second preset scanning driving signal corresponding to the preset data driving signal; and
taking a cycle in which two adjacent rows of sub-pixels are scanned as a driving cycle, and driving odd-numbered column of sub-pixels in the first row and even-numbered column of sub-pixels in the second row by the first preset scanning driving signal, and driving even-numbered column of sub-pixels in the first row and odd-numbered column of sub-pixels in the second row in the driving cycle by the second preset scanning driving signal.

13. The driving device according to claim 12, wherein polarities of two adjacent sub-pixels is set to be opposite.

14. The driving device according to claim 12, wherein a same column of sub-pixels is driven with a same data driving signal.

15. The driving device according to claim 12, wherein two adjacent sub-pixels in a same column are driven by the preset data driving signal, and the preset data driving signal is an average value of historical driving signals of the two adjacent sub-pixels.

16. The driving device according to claim 12, wherein an inversion signal is received, the first preset scanning driving signal and the preset data driving signal are inverted according to the inversion signal, an inverted first preset scanning driving signal and an inverted preset data driving signal are obtained and a driving time of the inverted first preset scanning driving signal is shortened, so that a driving time of the first preset scanning driving signal corresponding to the inverted preset data driving signal is shortened.

17. The driving device according to claim 12, wherein the pixel units comprises a first pixel unit and a second pixel unit alternately disposed in a column direction, wherein the first pixel unit comprises red sub-pixels, green sub-pixels, blue sub-pixels and white sub-pixels sequentially arranged, and the second pixel unit comprises blue sub-pixels, white sub-pixels, red sub-pixels, and green sub-pixels sequentially arranged; and
taking the cycle in which two adjacent rows of sub-pixels are scanned as the driving cycle, the red sub-pixels and the blue sub-pixels in the first row and the white sub-pixels and the green sub-pixels in the second row are driven by the first preset scanning driving signal, and the green sub-pixels and the white sub-pixels in the first row and the blue sub-pixels and the red sub-pixels in the second row in the driving cycle are driven by the second preset scanning driving signal.

18. The driving device according to claim 12, wherein the first pixel unit and the second pixel unit are disposed alternately in a first direction and a second direction, wherein the first direction is a row direction and the second direction is a column direction.

19. The driving device according to claim 12, wherein the odd-numbered columns of sub-pixels in the first row and the even-numbered columns of sub-pixels in the second row are scanned by a same scanning driving line and a same scanning driving signal, and the even-numbered columns of sub-pixels in the first row and the odd-numbered column of sub-pixels in the second row in the driving cycle are scanned by a same scanning driving line and a same scanning driving signal.

20. The driving device according to claim 12, wherein the first preset scanning driving signal and the second preset scanning driving signal drive sub-pixels of two adjacent rows in an interspersed manner.
